(19) United States
(12) Patent Application Publication
(10) Pub. No.: US 2025/0312860 A1
(43) Pub. Date: Oct. 9, 2025

(54) METHOD AND APPARATUS FOR MANUFACTURING A METAL STRUCTURE

(71) Applicant: FORG3D LTD, Edinburgh (GB)

(72) Inventors: Robert GRAHAM, East Kilbride, Glasgow (GB); Maxim MOROZOV, East Kilbride, Glasgow (GB)

(73) Assignee: FORG3D LTD, Edinburgh (GB)

(21) Appl. No.: 18/865,360

(22) PCT Filed: May 12, 2023
(86) PCT No.: PCT/GB2023/051259

§ 371 Date: Nov. 13, 2024

(30) Foreign Application Priority Data
May 13, 2022 (GB) 2207041.1

(51) Int. Cl. B23K 9/04; B23K 9/16; B23K 103/14; B33Y 10/00; B33Y 30/00; B33Y 40/20

(52) U.S. Cl. CPC B23K 9/04; B23K 9/16; B23K 2103/14; B33Y 10/00; B33Y 30/00; B33Y 40/20

(57) ABSTRACT

(FIG. 1) 1 2 The present disclosure provides a method of manufacturing a metal structure (1). The 3 method comprises: depositing molten metal material to form a first deposit region on a 4 support (102); and depositing further molten metal material to form a plurality of further 5 deposit regions forming, together with the first deposit region, the metal structure. Each 6 further deposit region is arranged to at least partially contact and overlap a respective 7 at least one previously solidified deposit region of the first deposit region and the 8 plurality of further deposit regions when all of the deposited metal material forming the 9 at least one previously solidified deposit region has cooled to have a temperature within 10 a threshold temperature range. The threshold temperature range has an upper bound 11 lower than a solidification temperature of the metal material and a lower bound greater 12 than 100 degrees Celsius. 13 14 METHOD AND APPARATUS FOR MANUFACTURING A METAL STRUCTURE15 16

### FIELD OF THE INVENTION

The present invention relates to a method of manufacturing a metal structure and an associated apparatus for performing the method.

### BACKGROUND TO THE INVENTION

Metal components are used in a variety of devices. In some cases, it is desirable to obtain large components, formed from metal.

One method which is used to form some components of this type entails machining the required shape of the component from a large billet of material. Initially, the billet has a substantially uniform cross-sectional shape (such as a cuboid of material). For many parts, the final desired component takes up only a small fraction of the initial volume, though it's extent in each of three transverse dimensions may extend almost to the edge of the billet. To remove all of the excess material by machining is an energy- intensive and time-consuming process, which often generates significant amounts of waste material, which either needs to be re-processed for re-use (requiring yet more energy), or which is thrown away.

For some components, metal casting or forging is used to obtain a shape which nearly or exactly matches the final shape of the required component. It may be that a machining process is used to finalise the manufacturing by removing a small amount of excess material. Whilst such processes generate less excess material than machining a full billet, and therefore requires less machining, casting and forging have long lead times.

Additive manufacturing techniques represent a different approach, whereby material is deposited, one layer at a time, to manufacture the component. However, some additive manufacturing techniques of the prior art can result in columnar microstructure of deposited metal, causing anisotropic mechanical properties and resultant poor structural performance of the component.

It is in this context that the present invention has been devised.

### SUMMARY OF THE INVENTION

In accordance with an aspect of the present disclosure, there is provided a method of manufacturing a metal structure. The method comprises: depositing molten metal material to form a first deposit region on a support; and depositing further molten metal material to form a plurality of further deposit regions forming, together with the first deposit region, the metal structure, each further deposit region arranged to at least partially contact and overlap a respective at least one previously solidified deposit region of the first deposit region and the plurality of further deposit regions when all of the deposited metal material forming the at least one previously solidified deposit region has cooled to have a temperature within a threshold temperature range. The threshold temperature range has an upper bound lower than a solidification temperature of the metal material and a lower bound greater than 100 degrees Celsius.

The first deposit region and the plurality of further deposit regions can be considered to, together, make up a plurality of deposit regions. It will also be understood that all of the deposited metal material forming the at least one previously solidified deposit region will be considered to have cooled to have a temperature within the threshold temperature range as long as no part of the at least one previously solidified deposit region is outside the threshold temperature range, even if different parts of the at least one previously solidified deposit region are at different temperatures.

Thus, by depositing the molten metal material in a plurality of deposit regions, sometimes referred to as spots, the molten metal material forming each deposit region can solidify in a more controlled manner than if the molten metal material was deposited continuously. By ensuring rapid solidification of the deposit region, the grain structure is typically less columnar and more equiaxed. Furthermore, by depositing further deposit regions when all of the deposited metal material forming the at least one previously solidified deposit region has a temperature within the threshold temperature range, the previously solidified deposit region can be entirely solidified, but also still sufficiently hot that stresses in the deposit region are reduced. By having reduced stresses, this also reduces or even completely eliminates cracking in the metal material during cooling. Accordingly, this results in a metal structure having particularly good mechanical properties, such as elongation and tensile strength.

In accordance with another aspect of the present disclosure, there is provided apparatus for manufacturing a metal structure. The apparatus is configured to perform the method described herein. Typically, the apparatus comprises: a support on which the metal structure is formed; a deposition arm configured to be supplied with a source of a metal material; and a controller configured to: cause the deposition arm to deposit molten metal material to form a first deposit region on the support; and cause the deposition arm to deposit further molten metal material to form a plurality of further deposit regions forming, together with the first deposit region, the metal structure, each further deposit region arranged to at least partially contact and overlap a respective at least one previously solidified deposit region of the first deposit region and the plurality of further deposit regions when all of the deposited further metal material forming the at least one previously solidified deposit region has cooled to have a temperature within a threshold temperature range. The threshold temperature range has an upper bound lower than a solidification temperature of the metal material and a lower bound greater than 100 degrees Celsius.

Thus, the apparatus can be used to obtain the benefits of the method described hereinbefore.

It will be understood that the metal material may be substantially any metal material having a solidification temperature greater than 100 degrees Celsius. Typically, the metal material is a metal material where unfavourable microstructure is formed if the metal is allowed to cool slowly from a molten deposition temperature. The metal material may be an alloy. The metal material may comprise titanium. The metal material may be an alloy of titanium. The titanium alloy may comprise aluminium. The titanium alloy may comprise vanadium. The titanium alloy may exist partially in an alpha phase. The titanium alloy may exist partially in a beta phase. The titanium alloy may be an alpha-beta titanium alloy. The titanium alloy may be Ti-6Al-4V. The metal material may be an alloy of iron, such as steel. The metal material may be an alloy of nickel.

The upper bound of the threshold temperature range may be more than 20 degrees below the solidification temperature. The upper bound of the threshold temperature range may be more than 50 degrees below the solidification temperature. The upper bound of the threshold temperature range may be more than 100 degrees below the solidification temperature. The upper bound may be greater than a temperature 500 degrees below the solidification temperature. The upper bound may be greater than a temperature 200 degrees below the solidification temperature. The upper bound of the threshold temperature range may be less than 1500 degrees below the solidification temperature. The upper bound of the threshold temperature range may be less than 1000 degrees below the solidification temperature. Where the metal material is an alloy of titanium, the upper bound may be greater than 1500 degrees Celsius. Where the metal material is an alloy of titanium, the upper bound may be less than 1600 degrees Celsius.

The lower bound of the threshold temperature range may be more than 500 degrees below the solidification temperature. The lower bound of the threshold temperature range may be more than 1000 degrees below the solidification temperature. The lower bound of the threshold temperature range may be greater than 150 degrees Celsius. The lower bound of the threshold temperature range may be greater than 200 degrees Celsius. The lower bound of the threshold temperature range may be less than 1000 degrees Celsius. The lower bound of the threshold temperature range may be less than 600 degrees Celsius. The lower bound of the threshold temperature range may be less than 500 degrees Celsius. Thus, it may be that at least some of the at least one previously solidified deposit region does not cool too much before the further molten metal material is deposited to form the respective further deposit region to at least partially contact and overlap the at least one previously solidified deposit region. As a result, this promotes formation of a stronger bond between contacting deposit regions each having temperatures near the solidification temperature. In particular, the surface tension of the metal material is still relatively low at temperatures within 500 degrees Celsius of the solidification temperature, making it easier for contacting deposit regions to bond without significant irregularities in the bond. Furthermore, if the further molten metal material forming the further deposit regions is deposited when the at least one previously solidified deposit region has cooled too much, fusion defects can form in the metal structure, which reduces the strength of the bond between deposit regions. Accordingly, the lower bound of the threshold temperature range may be sufficiently high so as to reduce or even substantially prevent formation of fusion defects between deposit regions.

The method may comprise determining whether a temperature of the at least one previously solidified deposit region is below a first threshold temperature. The 8 controller may be configured to determine whether a temperature of the at least one previously solidified deposit region is below the first threshold temperature. It may be that deposition of the further molten metal material to form the respective further deposit region is in dependence on the temperature of the at least one previously solidified deposit region being below the first threshold temperature. The first threshold temperature may be less than or equal to the upper bound of the threshold temperature range. The first threshold temperature may be substantially equal to the upper bound of the threshold temperature range.

The molten metal material may be deposited by welding. In other words, it may be that the deposition arm is a welding arm. The welding may be short-circuit transfer welding. The welding may be cold metal transfer welding.

It will be understood that welding encompasses substantially any process in which a portion of the source of metal material is heated until molten, for deposition to form the metal structure. The portion of the metal material may be heated by substantially any known method of heating, used in welding processes. Although welding is sometimes used to join two components together, with the molten metal material forming a structural linkage between the two components, this is not typically the case in the method and apparatus described herein, where it is the molten metal material itself which is used to form the metal structure. Nevertheless, it will be understood that this is still considered to be a welding process.

It will further be understood that the molten metal material may be deposited to form a deposit region either continuously, in one continuous stream, or as a plurality of separate molten droplets.

The depositing of the further molten metal material to form the plurality of further deposit regions may comprise depositing a first volume of the further molten metal material to form first subset of the plurality of further deposit regions to provide a first portion (e.g. layer) of the metal structure, and depositing a second volume of the further molten metal material to form a second subset of the plurality of further deposit regions to provide a second portion (e.g. layer) of the metal structure.

It may be that the controller is configured to cause the deposition arm to deposit a first volume of the further molten metal material to form first subset of the plurality of further deposit regions to provide a first portion (e.g. layer) of the metal structure, and depositing a second volume of the further molten metal material to form a second subset of the plurality of further deposit regions to provide a second portion (e.g. layer) of the metal structure.

Thus, the metal structure can be made up of several layers, each layer formed from a plurality of the further deposit regions.

The method may further comprise depositing one or more further volumes of the further molten metal material to form one or more further subsets of the plurality of further deposit regions to provide one or more further respective portions (e.g. one or more respective further layers) of the metal structure, each further subset deposited onto a preceding subset providing a preceding respective portion (e.g. preceding respective layer) of the metal structure. Correspondingly, it may be that the controller is configured to cause the deposition arm to deposit one or more further volumes of the further molten metal material to form one or more further subsets of the plurality of further deposit regions to provide one or more further respective portions (e.g. one or more respective further layers) of the metal structure, each further subset deposited onto a preceding subset providing a preceding respective portion (e.g. preceding respective layer) of the metal structure.

Each of the first subset of the plurality of the further deposit regions may be deposited to provide the first portion before any of the second subset of the plurality of further deposit regions are deposited onto the first portion. Thus, the metal structure is formed layer by layer, with each whole layer being completely formed before forming the next layer.

The second portion may be provided on the first portion. During deposition of the second volume of the further molten metal material to form the second subset of the plurality of the further deposit regions to provide the second portion of the metal structure, a first subset temperature of a surface of each of the first subset of the plurality of further deposit regions onto which the further molten metal material to form the second subset of the plurality of further deposit regions is deposited may be less than a temperature at which environmental contamination occurs. During deposition of the second volume of the further molten metal material to form the second subset of the plurality of the further deposit regions to provide the second portion of the metal structure, a second subset temperature of a surface of at least one of the second subset of the plurality of further deposit regions already deposited and to be contacted 8 by a currently deposited deposit region within the plurality of further deposit regions, may be greater than a temperature at which environmental contamination occurs. Thus, previously-deposited portions of the metal structure can be allowed to cool to a temperature where environmental contamination is significantly reduced, or even entirely prevented, but still pre-heated to obtain the attendant mechanical benefits during manufacture, whilst deposit regions forming the current portion of the metal structure, and to be contacted by the present deposition can remain at a higher temperature, ensuring an even stronger bond is provided between such deposit regions across the current portion of the metal structure.

It may be that during deposition of the second volume of the further molten metal material to form the second subset of the plurality of the further deposit regions to provide the second portion of the metal structure, a second subset temperature of a surface of the or each of the second subset of the plurality of further deposit regions already deposited and to be contacted by a currently deposited deposit region within the plurality of further deposit regions, is greater than a temperature at which environmental contamination occurs.

The first subset temperature may be less than 500 degrees Celsius. The first subset temperature may be less than 420 degrees Celsius. The first subset temperature may be less than 400 degrees Celsius. The first subset temperature may be substantially equal to the lower bound of the threshold temperature range.

The second subset temperature may be greater than 500 degrees Celsius. The second subset temperature may be greater than 1000 degrees Celsius. The second subset temperature may be greater than 1300 degrees Celsius. The second subset temperature may be substantially equal to the upper bound of the threshold temperature range.

It will be understood that substantially any deposition pattern of the deposit regions in each layer may be used.

The method may comprise abrading one or more of the plurality of deposit regions after deposition. The method may comprise abrading, at least partially, each of the plurality of deposit regions, after deposition of each respective deposit region.

The method may comprise, after the first subset of the plurality of the further deposit regions are deposited to provide the first portion, abrading an exposed surface of the first portion prior to depositing any of the second subset of the plurality of further deposit regions onto the exposed surface of the first portion.

The apparatus may comprise an abrading tool movable relative to the support. The controller may be configured to cause the abrading tool to abrade one or more solidified deposit regions after deposition. The controller may be configured to cause the abrading tool to, after the first subset of the plurality of deposit regions are deposited to form the first portion, abrade the first portion prior to any of the second subset of the plurality of deposit regions being deposited onto the first portion.

Thus, dirt, soot, an oxide film, spatter or morphological irregularities can be removed from one layer before depositing the next layer.

Abrading may comprise brushing. Abrading may comprise grinding. Abrading may comprise cleaning. It may be that the abrading tool comprises a brush. It may be that the abrading tool comprises a grinding tool.

At least one of the plurality of deposit regions may be in the form of a solidified spot having a surface area less than 2500 square millimetres. It may be that at least 50 percent of the plurality of deposit regions are each in the form of a solidified spot having a surface area less than 2500 square millimetres. It may be that each of the plurality of deposit regions are each in the form of a solidified spot having a surface area less than 2500 square millimetres.

At least one of the plurality of deposit regions may be in the form of a solidified spot having a surface area less than 1500 square millimetres. It may be that at least 50 percent of the plurality of deposit regions are each in the form of a solidified spot having a surface area less than 1500 square millimetres. It may be that each of the plurality of deposit regions are each in the form of a solidified spot having a surface area less than 1500 square millimetres.

At least one of the plurality of deposit regions may be in the form of a solidified spot having a surface area less than 1000 square millimetres. It may be that at least 50 percent of the plurality of deposit regions are each in the form of a solidified spot having a surface area less than 1000 square millimetres. It may be that each of the plurality of deposit regions are each in the form of a solidified spot having a surface area less than 1000 square millimetres.

At least one of the plurality of deposit regions may be in the form of a solidified spot having a surface area less than 500 square millimetres. It may be that at least 50 percent of the plurality of deposit regions are each in the form of a solidified spot having a surface area less than 500 square millimetres. It may be that each of the plurality of deposit regions are each in the form of a solidified spot having a surface area less than 500 square millimetres.

It will be understood that the surface area referred to hereinbefore is the surface area of the deposit region exposed immediately upon solidification of the molten metal material, prior to any covering of the deposit region as a result of deposition of further deposit regions on the same layer, or on any overlying layers.

At least one of the plurality of deposit regions may be in the form of a solidified spot having a surface area greater than 10 square millimetres. It may be that at least 50 percent of the plurality of deposit regions are each in the form of a solidified spot having a surface area greater than 10 square millimetres. It may be that each of the plurality of deposit regions are each in the form of a solidified spot having a surface area greater than 10 square millimetres.

It will be understood that the term “square millimetres” (such as “500 square millimetres”) means an area made up of the specified number of square millimetres (1 mm×1 mm).

Accordingly, at least some of the deposit regions are sized to be sufficiently small, causing the molten metal material forming the deposit region to cool and solidify in a controlled manner so that columnar microstructure is reduced, or even almost completely prevented. As a result, the mechanical properties of the metal structure can be particularly good.

It may be that the surface area of the deposit regions may be chosen to be sufficiently small that the molten metal material solidifies in less than one second. The surface area of the deposit regions may be chosen to be sufficiently small that the molten metal material solidifies in less than 0.5 seconds. The surface area of the deposit regions may be chosen to be sufficiently small that the molten metal material solidifies in less than 0.25 seconds. Thus, where the molten metal material is deposited using short-circuit transfer welding, the time between the end of a first welding arc used to deposit a first deposit region and the start of a second welding arc used to deposit a second deposit region can approximately correspond to a minimum non-welding time between two sequential welding arcs. In other words, the deposit regions can be sufficiently small to ensure that the molten metal material is solidified after deposition of a first deposit region before it is possible to begin deposition of further molten metal material to form a second deposit region.

It may be that each of the plurality of deposit regions have a substantially identical size.

The solidified spot may define an outline having an aspect ratio of length to width in a plane of the support of less than two. It will be understood that a particularly elongate shape will have a fairly large length to width aspect ratio where length is the largest dimension (such as much greater than two), but could also be considered to have a very small aspect ratio where width is the largest dimension (such as much less than 0.5). Thus, it may be that the aspect ratio of length to width in a plane of the support region is greater than 0.5. In other words, the solidified spot may define an outline for which a length does not differ by more than a factor of from a width, or vice versa. In some examples, the solidified spot may define a substantially circular outline. It has been found that having an aspect ratio relatively close to one ensures that formation of columnar microstructure is significantly reduced, compared to deposition of elongate portions of the metal material (having aspect ratios far removed from one). Accordingly, reducing the presence of columnar crystallites (i.e. columnar grains) in the microstructure ensures improved mechanical properties of the resulting metal structure.

The method may comprise heating to a pre-heat temperature. It may be that the support is heated to the pre-heat temperature. It may be that at least an outer surface of a deposit region onto which further deposit regions are to be formed is heated to the pre-heat temperature. The method may comprise maintaining the temperature at the pre-heat temperature during deposition of the plurality of deposit regions onto the support or the outer surface of the deposit region. The apparatus may comprise a heater. The heater may be configured to heat the support. The heater may be configured to heat an outer surface of a deposit region onto which further deposit regions are to be formed. The controller may be configured to cause the heater to heat to a pre-heat temperature. The controller may be configured to cause the heater to maintain a temperature at the pre-heat temperature. Thus, residual stress in the metal structure can be reduced during manufacture because the interface tension of the plurality of deposit regions forming the metal structure can be relaxed. As a result, the risk of cracking of the deposit regions during solidification is reduced. It will be understood that control of heating may be manual, semi-automated or fully automated, and can be achieved using substantially any conventional heating technology, ncluding substantially any heating control system, such as a proportional-integral-derivative (PID) control system.

The pre-heat temperature may be greater than 100 degrees Celsius. The pre-heat temperature may be less than the solidification temperature of the metal material. The pre-heat temperature may be greater than 150 degrees Celsius. The pre-heat temperature may be less than 1000 degrees Celsius. The pre-heat temperature may be less than 500 degrees Celsius.

Depositing the molten metal material to form the plurality of deposit regions to form the metal structure may comprise flooding an area including a respective deposit region with an inert gas during deposition. In this way, an ability for the deposit region to oxidise after deposition can be reduced.

The controller may be configured to cause the apparatus to flood an area including a respective deposit region with an inert gas during deposition of the molten metal material to form the plurality of deposit regions.

The inert gas may be a mixture of gases. The inert gas may comprise helium. The inert gas may comprise argon. The apparatus may comprise a shield member arranged to partially retain the inert gas in the area including the deposit region, whilst cooling.

Depositing the molten metal material to form the plurality of deposit regions may comprise causing vibration (e.g. mechanical vibration) of the plurality of deposit regions. Thus, any gaseous bubbles in the deposit regions can be caused to be shrunk and/or dislodged from the deposit regions prior to solidification.

The controller may be configured to cause the apparatus to vibrate (e.g. mechanically vibrate) the plurality of deposit regions during deposition of the molten metal material onto the support.

The vibration may continue for at least a first time period after deposition of each deposit region. The vibration may continue for at least one second after deposition of each deposit region.

The method may further comprise machining the metal structure. Thus, a final shape of a metal component can be formed by machining the metal structure to remove remaining excess material. Machining the metal structure may occur after the plurality of deposit regions have been formed on the support by deposition of the molten metal material to form the metal structure.

The apparatus may further comprise a machining tool configured to machine the metal structure. The controller may be configured to cause the machining tool to machine the metal structure after the plurality of deposit regions have been formed on the support by deposition of the molten metal material to form the metal structure.

In some examples, the metal structure may be machined during deposition of the plurality of deposit regions on the support. For example, the method may comprise depositing a first subset of the plurality of deposit regions onto the support, depositing a second subset of the plurality of deposit regions onto the support subsequent to depositing the first subset of the plurality of deposit regions, and machining the metal structure after the first subset of the plurality of deposit regions have been deposited, and before any of the second subset of the plurality of deposit regions have been deposited. It may be that the metal structure is machined a plurality of times between when the first deposit region of the plurality of deposit regions is deposited and when a final deposit region of the plurality of deposit regions is deposited.

It may be that deposit regions in a given layer are arranged in a predetermined pattern. For example, the predetermined pattern may be any one of square, hexagonal, or any other suitable pattern.

The plurality of deposit regions may be deposited in substantially any order. In other words, the immediately preceding deposit region to be deposited need not be the same deposit region to which a current deposit region will be in contact.

A weave pattern during deposition of each deposit region may be substantially any weave pattern, such as triangular, trapezoidal, rectangular, circular, spiral, or any other suitable pattern. The weave pattern may be the same for each deposit region. In some examples, there may be no weave pattern and a deposit region may be deposited without any further lateral movement of the deposition arm relative to the support during the deposition of the deposit region.

In accordance with a further aspect of the present invention, there is provided a metal component manufactured according to the method disclosed herein, or using the apparatus disclosed herein. Thus, a metal component can be manufactured by means of a process which can create a finished component having particularly good mechanical properties, yet not resulting in a large amount of waste material, compared to machining the metal component from a cuboidal billet of the metal material. It will be understood that an inspection of the microstructure of the metal component will make it apparent that the metal component was formed by deposition of molten metal material onto a support, to form the plurality of deposit regions, where adjacent deposit regions are deposited onto the neighbouring deposit region only when the temperature of the neighbouring deposit region has cooled to be within the threshold temperature range; the microstructure would look different if the metal component was instead cast, or formed using any other manufacturing technique.

In accordance with a still further aspect of the present invention, there is provided a computer-readable storage medium having instructions stored thereon. The instructions, when executed by one or more processors of the controller described herein, are configured to cause the apparatus to perform one or more, or all of the steps of the methods described herein.

The controller may comprise one or more processors and a memory configured to store instructions which when executed by the one or more processors cause the apparatus to carry out the commands of the controller. The memory may be non-transitory, computer-readable memory. The memory may have the instructions stored thereon. The present invention extends to a non-transitory computer-readable medium (e.g. memory) having the instructions stored thereon to control the apparatus as described herein. The memory may be solid-state memory. The controller may be provided in a single device. In other example, the controller may be distributed, having a plurality of processors. A first processor may be separated from a second processor in a distributed manner.

The controller may be configured to carry out substantially any of the methods and or steps described herein, unless inherently incompatible.

### DESCRIPTION OF THE DRAWINGS

An example embodiment of the present invention will now be illustrated with reference to the following Figures in which:

FIG. 1 shows an example of apparatus for manufacturing a metal structure, according to an embodiment of the present invention;

FIG. 2 illustrates microstructure of a metal structure, as formed without using the deposition technique described herein;

FIG. 3 illustrates microstructure of a metal structure, as formed using a deposition technique according to an embodiment of the present invention;

FIG. 4 illustrates a view of a layer of a metal structure, during the manufacturing process according to an embodiment of the present invention;

FIG. 5 is flowchart illustrating steps of a method according to an embodiment of the present invention; and

FIG. 6 schematically illustrates an apparatus including a controller, according to an embodiment of the present invention.

### DETAILED DESCRIPTION OF AN EXAMPLE EMBODIMENT

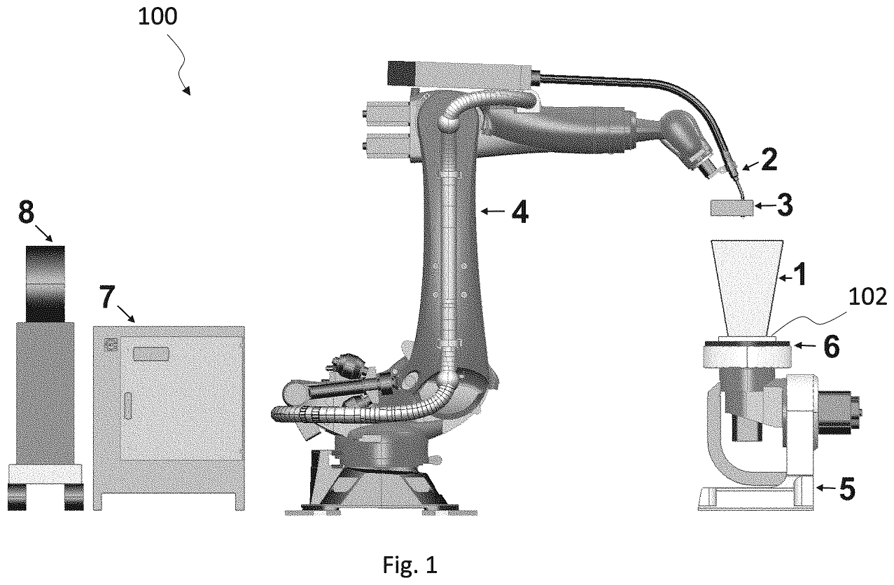

FIG. 1 shows an example of apparatus for manufacturing a metal structure, according to an embodiment of the present invention. The apparatus 100 comprises a support region 102, sometimes referred to simply as a support 102. The support region 102 is in the form of a platform 102 on which a metal structure can be formed. Typically, the support region 102 is formed from either the same material as the metal structure 1, or from another material to which the metal structure 1 can readily bond. The metal structure 1 can be considered to be an additively manufactured part 1, as will be described further hereinafter. The apparatus 100 further comprises a deposition arm in the form of a robotic arm 4, comprising a welding tool 2 in the form of a welding torch 2. The welding tool is supplied with a source of a metal material to be deposited onto the support region 102 to form the metal structure 1, using the welding tool 2. In this example, the welding tool 2 is specifically provided with a trailing shield 3, also including an integrated camera and other sensors, for monitoring the deposition of the metal material from the welding tool 2. The metal material is provided to the deposition arm 4 by a wire-feeding mechanism 8. It will be understood that the deposition arm 4, and specifically the welding tool 2 of the deposition arm 4 can be supplied with power to operate the welding tool 2 from a welding power source, in this example integrated with the wire-feeding mechanism 8. The deposition arm 4 is typically movable so as to change the position of the welding tool 2 relative to the metal structure 1. The apparatus 100 further comprises a pre-heat source 6 arranged to heat the support region 102, and thereby also the metal structure 1 to a pre-heat temperature during operation. In this example, the apparatus 100 further comprises an external positioner 5 for moving the support region 102, and therefore also the metal structure 1, whereby to allow movement and/or re-orientation of the metal structure 1 relative to the welding tool 2 during operation. In this example, the external positioner 5 also includes a vibration inducer and transducer operable to cause vibration of the metal structure 1 during manufacture, as well as for use in ultrasonic testing of the metal structure 1, during manufacture. The apparatus 100 also includes a controller 7, for controlling the deposition arm 4, including the welding tool 2, as well as the pre-heat source 6, the external positioner 5, and the wire-feeding mechanism 8. The metal material in this example is an alloy of titanium, Ti-6Al-4V.

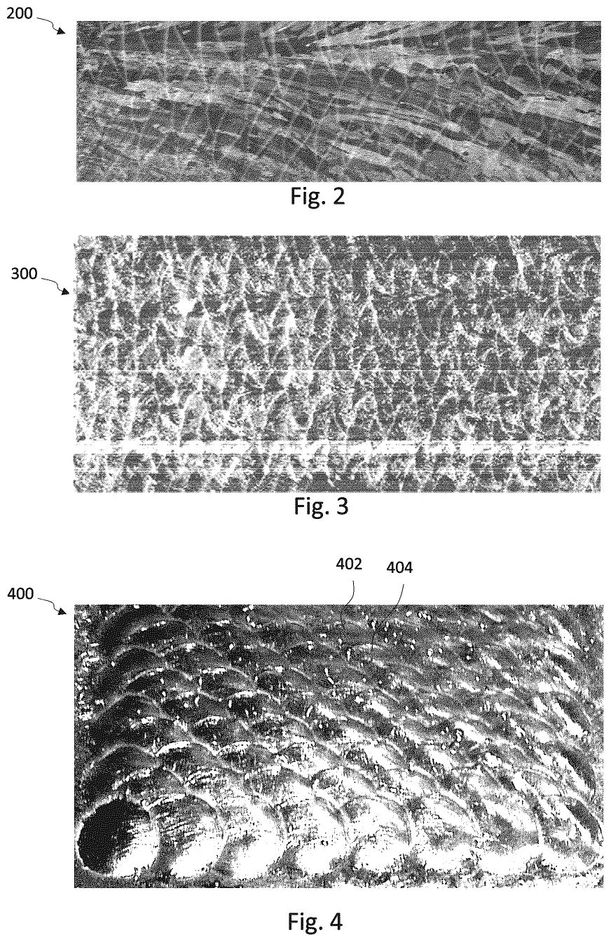

FIG. 2 illustrates microstructure of a metal structure, as formed without using the deposition technique described herein. Specifically, the metal structure shown in FIG. 2 has been formed using a metal deposition technique in which the metal material (in this case Titanium allow Ti-6Al-4V) is deposited in elongate sections at once. As a result, the microstructure 200 is characterised by formation of columnar crystallites (grains) orientated along the build direction. It has been found that columnar microstructure of this type results in anisotropic mechanical properties and therefore reductions in structural performance of the resulting metal components.

FIG. 3 illustrates microstructure of a metal structure, as formed using a deposition technique according to an embodiment of the present invention. In contrast to the microstructure in FIG. 2, the metal material shown deposited in FIG. 3 has been deposited in a plurality of separate deposit regions, with each deposit region having cooled to be within a threshold temperature range having an upper bound below a solidification temperature of the metal, before depositing further metal material to form another deposit region to contact the earlier deposit region. As a result, formation of columnar crystallites (grains) is significantly reduced, which reduces anisotropic variations in mechanical properties, thereby avoiding significant reductions in structural performance of the resulting metal components.

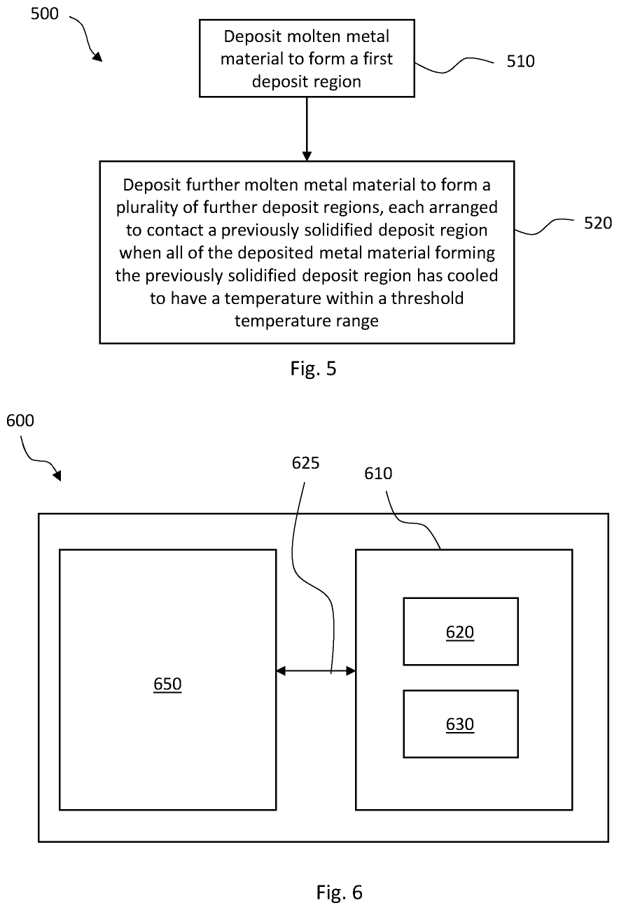

FIG. 4 illustrates a view of a layer of a metal structure, during the manufacturing process, according to an embodiment of the present invention. The layer 400 is formed from a plurality of deposit regions 402, 404, as per the method described further hereinafter with reference to FIG. 5. As can be seen, a first deposit region 402 is eposited and allowed to solidify, with a second deposit region 402 deposited to contact and partially overlap the first deposit region 402. In this way, the whole layer 400 can be built up. In this example, the layer 400 has also been brushed to remove soot, oxide film, spatter and morphological irregularities, ready for deposition of the next layer thereon.

FIG. 5 is a flowchart illustrating steps of a method according to an embodiment of the present invention. The method 500 will be explained also with reference to the apparatus shown in FIG. 1 and described hereinbefore. The method 500 is for manufacturing a metal structure 1. In brief, the method 500 comprises depositing 510 molten metal material to form a first deposit region and depositing 520 further molten metal material to form a plurality of further deposit regions each to contact a respective previously solidified deposit region when the temperature of the previously solidified deposit region is below an upper bound of a threshold temperature range.

Specifically, the method 500 comprises depositing 510, 520 molten metal material to form a plurality of deposit regions on the support region 102 to form the metal structure 1. As shown in FIG. 5, depositing the molten metal material to form the plurality of deposit regions comprises depositing 510 molten metal material to form a first deposit region on the support region 102, and, subsequently, depositing 520 further molten metal material to form a plurality of further deposit regions forming, together with the first deposit region, the metal structure. Each further deposit region is arranged to at least partially contact and overlap a respective at least one previously solidified deposit region when all of the deposited metal material forming the at least one previously solidified deposit region has cooled to have a temperature within a threshold temperature range. The threshold temperature range has an upper bound lower than a solidification temperature of the metal material and a lower bound greater than 100 degrees Celsius.

There are typically hundreds, if not thousands, perhaps even tens of thousands or more of deposit regions formed by depositing molten metal material, to form the metal structure. Each of these (apart from the very first) is deposited so as to at least partially contact and overlap at least one respective other of the plurality of deposit regions, previously solidified, when the temperature of all of the molten metal material forming the respective other of the plurality of deposit regions is below the upper bound of the threshold temperature range. In this way, the metal material can quickly solidify and cool below the upper bound of the threshold temperature range by being deposited in small deposit regions, yet the metal structure can be formed by overlapping multiple deposit regions to build-up the required structure.

The method further comprises pre-heating the support region 102 (and therefore also the metal structure 1 during manufacture) using a pre-heat source 6, so that the temperature of the metal structure 1 does not fall too low, which can also detrimentally affect the structural properties of the manufactured metal structure 1. In this example, the pre-heat source pre-heats the support region 102 to around 200 degrees Celsius.

The process by which the molten metal material is deposited to form the plurality of deposit regions on the support region 102 is typically referred to as welding, in which the source of metal material (titanium alloy) is supplied, using the wire-feeding mechanism 8, to the welding tool 2 of the deposition arm 4. The titanium alloy is heated at the welding tool 2 until molten, at which point the titanium alloy is deposited in one or more droplets to form a deposit region onto the support region 102 (or onto a layer of deposit regions already deposited onto the support region 102). In this example, the particular form of welding is cold metal transfer welding, specifically short-circuit transfer welding, which avoids overheating the metal material, thereby also promoting formation of smaller grain sizes. Nevertheless, it will be understood that substantially any method of forming molten metal material for deposition, such as any other welding technique, can be used to achieve at least some of the benefits described herein.

The deposit regions in this example are sized so as to provide substantially circular spots, having a diameter of between 4 mm and 20 mm, for example 10 mm. The degree of overlap between adjacent deposit regions and the post-flow time is arranged to maintain a desired inter-pass temperature, and also to enable a more isotropic residual stress distribution in the build.

It will be understood that substantially any weave pattern and/or substantially any deposit region deposition pattern and/or substantially any deposit region deposition order can be used for deposition of the molten metal material to form the plurality of deposit regions, as long as any deposit regions contacted and partially overlapped by a newly deposited deposit region have already solidified and cooled below the upper bound of the threshold temperature range. To deposit the molten metal material to form deposit regions on the support region 102, either or both of the deposition arm 4 and the external positioner 5 are moved relative to each other so as to change the location on the support region 102 onto which each deposit region will be formed by deposition of molten metal material. It will be understood that in situations where the same relative position of the deposition arm 4 to the support region 102 could be achieved through movement of the deposition arm 4, or the external positioner 5, or a combination of the deposition arm 4 and the external positioner 5, it is typically preferable for the support region 102 and the deposition arm to be oriented in such a way that gravity acts on the metal structure 1 in such a way as to support manufacture of the metal structure 1, keeping in mind that molten metal material is deposited from the deposition arm 4 to fall in the direction of gravity.

It will also be understood that the inter-pass temperature can be controlled by substantially any known method, for example, using a sub-system including a suitable heating source (e.g., flame, inductive heating or laser) which receives feed-back from temperature measuring devices (e.g., thermocouples, infrared cameras etc.). Appropriately set post-flow times also pertain to the inter-pass temperature control.

During welding, a trailing shield 3 is used to deliver appropriate inert gas (e.g., argon, helium or any mix of gasses) to the welded area to reduce or even substantially prevent oxidation by displacing oxygen (or any other contaminating gases) from the welded area. Use of the trailing shield particularly ensures that no contaminating gases can react with the deposited metal material until the temperature has cooled to be sufficiently low that spontaneous reaction does not occur, typically below 420 degrees Celsius for Titanium alloy Ti-6Al-4V.

During and for a predetermined period of time after the deposition of molten metal material to form each deposit region, the vibration inducer of the external positioner 5 is operated to apply multidirectional mechanical vibration to the metal structure. The purpose of the vibration is twofold: (1) polycrystal grain refinement and degasification of the welding pool to achieve porosity reduction; (2) residual stress relief. The vibration detector (transducer) is used to measure parameters of the vibration. Frequency and intensity of vibration are optimised for each part using one of the following methods: (1) empirically: using a standard part a frequency sweep is performed and vibration spectrum of the part is acquired; optimal frequency and intensity of vibration are selected from the acquired spectrum and applied during the deposition; (2) numerical simulation; (3) analytical calculations. Shock absorbers (not labelled in FIG. 1) are used to mechanically decouple the metal structure from the external positioner 5.

Furthermore, mechanical properties of the metal structure 1 can be estimated and potential defects can be detected based on the oscillation spectrum (acoustic quality monitoring). If a significant deviation from the determined optimal vibration characteristics is detected which indicates flaws in the deposited part, the further deposition of molten metal material to form further deposit regions can be suspended, while defects are assessed and the metal structure 1 repaired if necessary. Alternatively, the additive manufacturing process can be completely aborted if the identified defect cannot be fixed.

The herein-described method can also include applying multidirectional ultrasonic vibration to control microstructure of the build. The frequency of the vibration is optimised for the particular geometry. Ultrasonic vibration can be either delivered by an appropriate sonotrode or induced using Electromagnetic Acoustic Transducer (EMAT).

After deposition of a complete layer of the metal structure 1, formed by molten metal material, deposited to form a plurality of solidified deposit regions, the completed layer is mechanically treated, such as being brushed and/or ground. In this way, morphological irregularities, soot, oxide film, spatter, or any other undesirable surface features can be removed prior to beginning deposition of the next layer of the metal structure 1.

During deposition, the use of sensors and a camera, for example provided as part of the trailing shield 3, can allow remote monitoring of the deposition process, either manually or automatically.

After complete deposition of the metal structure 1, further manufacturing steps are typically undertaken. In this example, further heat treatment of the metal structure 1 is undertaken to achieve desired mechanical properties of the metal structure 1. Furthermore, the metal structure 1 is typically further machined to remove any excess material to obtain a final shape matching the desired shape of a completed metal component.

Although only a single welding tool 2 is shown in FIG. 1, it will be understood that multiple, independently controlled welding tools, and/or multiple wire feeding mechanisms may be used in other examples.

The apparatus can also include an in-process non-destructive testing sub-system for detection of defects, of substantially any known type.

The apparatus can be configured to inspect the geometrical metrology of the metal structure 1 during deposition (such as after deposition of a first layer) and thereby monitor the geometrical dimensions. In dependence thereon, the deposition of a subsequent layer can be controlled, for example so as to ensure desired geometrical metrology of the next layer.

FIG. 6 schematically illustrates an apparatus including a controller, according to an embodiment of the present invention. The apparatus 600 can be considered to be the apparatus 100 of FIG. 1, and includes a controller 610 for controlling one or more electronic components 650 of the apparatus 600. The one or more electronic components include the deposition arm 4, the wire-feeding mechanism 8, the pre-heat source 6, the external positioner 5 and the trailing shield 5 (including any integrated sensors, such as a camera). In this example, the controller 610 is configured to control the deposition arm 4, and specifically the welding tool 2 of the deposition arm 4 via the controller 7, but it will be understood that in other examples, the controller 7 may be considered part of the controller 610. The controller exchanges signals (such as control signals and sensor data signals) via data communication pathway 625. It will be understood that the data communication pathway may comprise wired and/or wireless portions of the data communication pathway. The controller 610 comprises one or more processors 620 and a non-transitory, computer readable memory 630. The computer readable memory 630 stores instructions which, when executed by the one or more processors 620, causes the apparatus 600 to perform the methods as described herein.

In summary, there is provided a method of manufacturing a metal structure (1). The method comprises: depositing molten metal material to form a first deposit region on a support (102); and depositing further molten metal material to form a plurality of further deposit regions forming, together with the first deposit region, the metal structure. Each further deposit region is arranged to at least partially contact and overlap a respective at least one previously solidified deposit region of the first deposit region and the plurality of further deposit regions when all of the deposited metal material forming the at least one previously solidified deposit region has cooled to have a temperature within a threshold temperature range. The threshold temperature range has an upper bound lower than a solidification temperature of the metal material and a lower bound greater than 100 degrees Celsius.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of manufacturing a metal structure, the method comprising:
depositing molten metal material to form a first deposit region on a support; and
depositing further molten metal material to form a plurality of further deposit regions forming, together with the first deposit region, the metal structure, each further deposit region arranged to at least partially contact and overlap a respective at least one previously solidified deposit region of the first deposit region and the plurality of further deposit regions when all of the deposited metal material forming the at least one previously solidified deposit region has cooled to have a temperature within a threshold temperature range,
wherein the threshold temperature range has an upper bound lower than a solidification temperature of the metal material and a lower bound greater than 100 degrees Celsius,
wherein depositing the further molten metal material to form the plurality of further deposit regions comprises depositing a first volume of the further molten metal material to form a first subset of the plurality of the further deposit regions to provide a first portion of the metal structure, and depositing a second volume of the further molten metal material to form a second subset of the plurality of the further deposit regions to provide a second portion of the metal structure, and
wherein each of the first subset of the plurality of the further deposit regions are deposited to provide the first portion before any of the second subset of the plurality of further deposit regions are deposited to provide the second portion.

2. An apparatus for manufacturing a metal structure, the apparatus comprising:
a support on which the metal structure is formed;
a deposition arm configured to be supplied with a source of a metal material; and
a controller configured to:
cause the deposition arm to deposit molten metal material to form a first deposit region on the support; and
cause the deposition arm to deposit further molten metal material to form a plurality of further deposit regions forming, together with the first deposit region, the metal structure, each further deposit region arranged to at least partially contact and overlap a respective at least one previously solidified deposit region of the first deposit region and the plurality of further deposit regions when all of the deposited further metal material forming the at least one previously solidified deposit region has cooled to have a temperature within a threshold temperature range,
wherein the threshold temperature range has an upper bound lower than a solidification temperature of the metal material and a lower bound greater than 100 degrees Celsius,
wherein causing the deposition arm to deposit the further molten metal material to form the plurality of further deposit regions comprises causing the deposition arm to deposit a first volume of the further molten metal material to form a first subset of the plurality of the further deposit regions to provide a first portion of the metal structure, and to deposit a second volume of the further molten metal material to form a second subset of the plurality of the further deposit regions to provide a second portion of the metal structure, and
wherein each of the first subset of the plurality of the further deposit regions are caused to be deposited to provide the first portion before any of the second subset of the plurality of further deposit regions are deposited to provide the second portion.

3. The method as claimed in claim 1, wherein the metal material is titanium alloy.

4. The method as claimed in claim 1, wherein the lower bound is greater than 150 degrees Celsius.

5. The method as claimed in claim 1, wherein the upper bound is greater than a temperature 200 degrees below the solidification temperature of the metal material.

6. The method as claimed in claim 1, wherein the metal structure is manufactured solely from the deposited molten metal material.

7. The method as claimed in claim 1, wherein the molten metal material is deposited by welding.

8. The method as claimed in claim 1, wherein the second portion is provided on the first portion, and wherein, during deposition of the second volume of the further molten metal material to form the second subset of the plurality of the further deposit regions to provide the second portion of the metal structure:
a first subset temperature of a surface of each of the first subset of the plurality of further deposit regions onto which the further molten metal material to form the second subset of the plurality of further deposit regions is deposited is less than a temperature at which environmental contamination occurs; and
a second subset temperature of a surface of at least one of the second subset of the plurality of further deposit regions already deposited and to be contacted by a currently deposited deposit region within the plurality of further deposit regions, is greater than a temperature at which environmental contamination occurs.

9. The method as claimed in claim 1, wherein at least one of the plurality of deposit regions comprising the first deposit region and the plurality of further deposit regions is in the form of a solidified spot having a surface area less than 500 square millimetres.

10. The method as claimed in claim 1, wherein at least one of the plurality of deposit regions comprising the first deposit region and the plurality of further deposit regions is in the form of a solidified spot having a surface area greater than 10 square millimetres.

11. The method as claimed in claim 9, wherein the solidified spot defines an outline having an aspect ratio of length to width in a plane of the support of less than two.

12. The method as claimed in claim 1, comprising heating the support or an outer surface of a deposit region onto which further deposit regions are to be formed, to a pre-heat temperature and maintaining the temperature of the support or the outer surface of the deposit region at the pre-heat temperature during deposition of the plurality of deposit regions comprising the first deposit region and the plurality of further deposit regions onto the support or the outer surface of the deposit region.

13. The method as claimed in claim 1, wherein depositing the molten metal material to form the plurality of deposit regions comprising the first deposit region and the plurality of further deposit regions comprises flooding an area including a respective deposit region with an inert gas during deposition, whereby to reduce atmospheric contamination of the deposit region after deposition.

14. The method as claimed in claim 1, wherein depositing the molten metal material and the molten metal material to form the plurality of deposit regions comprises causing mechanical vibration of the plurality of deposit regions.

15. The method as claimed in claim 14, wherein the mechanical vibration continues for at least a first time period after deposition of each deposit region.

16. The method as claimed in claim 1, further comprising machining the metal structure.

17. A metal component manufactured according to the method of claim 1.

18. (canceled).

19. The method as claimed in claim 1, wherein the method comprises, after the first subset of the plurality of the further deposit regions are deposited to provide the first portion, abrading an exposed surface of the first portion prior to depositing any of the second subset of the plurality of further deposit regions onto the exposed surface of the first portion.

20. The apparatus as claimed in claim 2, further comprising an abrading tool that is movable relative to the support, wherein the controller is further configured to cause the abrading tool to, after the first subset of the plurality of the further deposit regions are deposited to form the first portion, abrade the first portion prior to any of the second subset of the plurality of further deposit regions being deposited onto the first portion.

21. The method as claimed in claim 7, wherein the molten metal material is deposited by short-circuit transfer welding.
